(19) United States
(12) Patent Application Publication
(10) Pub. No.: US 2025/0066220 A1
(43) Pub. Date: Feb. 27, 2025

(54) HIGH-ENTROPY SODIUM ION BATTERY CATHODE MATERIAL

(71) Applicant: Nankai University, Tianjin (CN)

(72) Inventors: Fujun Li, Tianjin (CN); Suning Gao, Tianjin (CN); Tong Zhang, Tianjin (CN); Xiangshuai Wei, Tianjin (CN); Wei Hu, Tianjin (CN)

(21) Appl. No.: 18/418,877

(22) Filed: Jan. 22, 2024

(30) Foreign Application Priority Data
Aug. 24, 2023 (CN) 202311068224.1

(51) Int. Cl. C01G 53/00; H01M 4/02; H01M 4/36; H01M 4/505; H01M 4/525; H01M 4/62; H01M 10/054

(52) U.S. Cl. CPC C01G 53/50; H01M 4/366; H01M 4/505; H01M 4/525; H01M 4/623; H01M 4/625; H01M 10/054; C01P 2002/72; C01P 2004/84; C01P 2006/40; H01M 2004/028

(57) ABSTRACT

The present invention belongs to the technical field in sodium ion battery, which includes material synthesis, and discloses a high-entropy cathode material with a chemical formula of Na₁₋ₓKₓNi_{y}Fe_{z}Mn_{d}TiₘZn_{1-y-z-d-m}O₂, wherein 0<x≤0.1, 0<y, z, d, and m≤1. Its crystallographic structure is a hexagonal system with a space group of R-3m, where the arrangement subsequence of transition metal layers is ABCABC. Ni, Fe, Zn, Mn and Ti elements occupy in a transition metal layer and are arranged in a disordered subsequence; Na and K elements sit in an alkali metal layer and are arranged in a disordered subsequence. The cathode material of this present invention exhibits excellent electrochemical performance with a high specific capacity of 150 mAhg⁻¹ at a high cut-off charge voltage of 4.3V, and the capacity retention of this pouch cell does not decay after 200 cycles.

### CROSS REFERENCE TO RELATED APPLICATIONS

This application claims foreign priority of Chinese Patent Application No. 202311068224.1, filed on Aug. 24, 2023 in the China National Intellectual Property Administration, the disclosures of all of which are hereby incorporated by reference.

### TECHNICAL FIELD

The present invention belongs to the technical field of sodium ion battery, which involves high-entropy cathode material synthesis and its application in sodium ion battery.

### BACKGROUND OF THE PRESENT INVENTION

Lithium resource is limited due to its 0.0065% content in the earth's crust. The increasing demands on electric vehicles and large-scale energy storage have spurs new generation battery technologies. Among these batteries, sodium ion battery has the advantages of low cost, environment friendliness and low supply risk, and it is reckoned as an important supplementation technology in the field of large-scale energy storage. Currently, the cathode materials mainly include layered transition metal oxides (NaTMO₂), polyanion-type cathode materials (Na₃M₂(PO₄)₃), Prussian materials (NaₓM₁[M₂(CN)₆]·mH₂O, 0<x≤2), and organic electrode materials. Layered transition metal oxides are gaining widespread attentions due to their high ionic/electronic conductivity, high theoretical specific capacity, and easy preparation.

O3-type NaₓTMO₂ has high theoretical specific capacity, but it has scientific issues such as severe phase transitions and surface/interface instability especially at high working voltages. These challenges lead to many efforts to conquer the capacity-lifespan issue. Currently, the charging cutoff voltages in O3-type NaₓTMO₂ are limited as 4.0V, and their specific capacities are merely 120-130 mAhg⁻¹. Therefore, many strategies such as ion doping and surface coating are proposed to reduce the volume effect of the structure and improve electric conductivity. However, they are hardly to be stable when elevating the cutoff charge voltage to 4.3V.

High-entropy materials are solid solutions consisting of more than five different elements (the content of each element is between 5 to 35%). The configurational entropy is increased along with the increase of elements. They can thermodynamically (ΔGₘᵢₓ=ΔHₘᵢₓ−TΔSₘᵢₓ) and dynamically form a more stable crystalline structure. CN116093326A reveals a cathode material and its preparation method. It consists of a high-entropy layered transition metal oxide with coated solid electrolyte layer. The high-entropy layered transition metal oxide has a chemical formula of NaTMO₂, where TM comprises at least five of Li, B, Mg, Al, Ca, Ti, V, Cr, Mn, Fe, Co, Ni, Cu, Zn, Y, Zr, Nb, Mo, Ru, Sn, Sb, Te, Ir and Bi. This cathode material achieves a specific capacity of 128.1 mAhg⁻¹ in the range of 2.0-4.2V, and its cycle retention is 94.5%. These exhibit promising prospects in the field of large-scale energy storage, but it is still difficult to meet the energy demand of the sodium ion battery in the field of low-speed electric vehicles.

### SUMMARY OF PRESENT INVENTION

The objective of the present invention is to overcome the defects as mentioned above, and to synthesize a high-entropy cathode material by regulating their configurational entropies. The severe P3-01 phase transition of such materials is alleviated during charge and discharge, which reduces the internal strain and thus solves the technical problems of high specific capacity and long cycle stability.

The technical solution achieving the objective of the present invention is as follows:

The present invention provides a high-entropy sodium ion battery cathode material, which has a chemical formula of Na₁₋ₓKₓNi_{y}Fe_{z}Mn_{d}TiₘZn_{1-y-z-d-m}O₂, wherein 0<x≤0.1, 0<y, z, d, and m≤1. It belongs to hexagonal system and has a space group of R-3m, where the arrangement subsequence of transition metal layers is ABCABC. Ni, Fe, Zn, Mn and Ti elements are occupied in the transition metal layer with a disordered subsequence; Na and K elements sit in the alkali metal layer and arranged in a disordered subsequence.

Preferably, x is 0.03-0.10, y is 0.20-0.50, z is 0.05-0.20, d is 0.10-0.40, and m is 0.10-0.20.

Further preferably, x is 0.05-0.08, y is 0.30-0.40, z is 0.08-0.12, d is 0.20-0.30, and m is 0.15-0.20.

Most preferably, the chemical formula of the high-entropy sodium ion battery cathode material is Na_{0.95}K_{0.05}Ni_{0.32}Zn_{0.08}Fe_{0.1}Mn_{0.3}Ti_{0.2}O₂ or Na_{0.92}K_{0.08}Ni_{0.32}Zn_{0.08}Fe_{0.1}Mn_{0.3}Ti_{0.2}O₂.

Through the synergistic effect of elements, high-entropy doping reduces lattice expansion/shrinkage and thereby inhibiting capacity attenuation.

In these cathode materials, different elements occupy the same crystallographic lattice site to form a solid solution, thereby stabilizing the structure of the material during charge and discharge. These ensure this cathode material with high specific capacity even at a high cut-off voltage, and excellent long cycle performance in sodium ion battery.

The present invention provides a preparation method of a high-entropy sodium ion battery cathode material, which comprises the following steps:
(1) performing ball milling and mixing on a sodium source, a potassium source, a nickel source, a manganese source, an iron source, a titanium source and a zinc source according to a stoichiometric ratio, and drying to obtain a precursor; and
(2) calcining the precursor obtained in step (1) for 10-15 h at 800-1000° C., and then cooling at a cooling rate of 5-10° C. min⁻¹ to obtain the high-entropy sodium ion battery cathode material.

The sodium source is sodium carbonate or sodium oxide, the potassium source is potassium carbonate, the nickel source is nickel oxide, the manganese source is manganese dioxide, the iron source is iron oxide, the titanium source is titanium dioxide, and the zinc source is zinc oxide.

The calcining temperature is preferably 850-950° C. The calcining atmosphere is air, nitrogen or oxygen, the calcining thermal treatment time is preferably 12-15 h, and the cooling rate is preferably 8-10° C. min⁻¹.

According to the present invention, the cathode material is prepared by a calcining method, and the preparation method of this present invention has the advantage of simple and large-scale operation.

The above-mentioned high-entropy cathode material is prepared into a CR-2032 coin cell, which comprises the following components by mass percent: 80% cathode material, 10% conductive black and 10% polyvinylidene fluoride.

### The Present Invention has the Advantages and Beneficial Effects

The high-entropy cathode material Na₁₋ₓKₓNi_{y}Fe_{z}Mn_{d}TiₘZn_{1-y-z-d-m}O₂ (0<x≤0.1, 0<y, z, d, and m≤1) provided by the present invention has excellent air stability. Meanwhile, the sodium ion battery assembled by using this cathode material has a specific capacity of 150 mAhg⁻¹ at a high cut-off charge voltage of 4.3V, and the capacity retention of the assembled pouch cell does not decay (about 100%) after 200 cycles.

### DESCRIPTION OF THE DRAWINGS

FIG. 1 is an X-ray diffraction (XRD) graph of Na_{0.95}K_{0.05}Ni_{0.32}Zn_{0.08}Fe_{0.1}Mn_{0.3}Ti_{0.2}O₂ prepared in example 1;

FIG. 2 is an XRD graph of Na_{0.92}K_{0.08}Ni_{0.32}Zn_{0.08}Fe_{0.1}Mn_{0.3}Ti_{0.2}O₂ prepared in example 2;

FIG. 3 is the charge and discharge curve of comparative example 1 (current density: 100 mAg⁻¹, electrolyte: 1.0 molL⁻¹, sodium hexafluorophosphate is dissolved in propylene carbonate, and the voltage window: 2.0-4.3 V);

FIG. 4 is the charge and discharge curve of comparative example 2 (current density: 100 mA g⁻¹, electrolyte: 1.0 mol L⁻¹, sodium hexafluorophosphate is dissolved in propylene carbonate, and the voltage window: 2.0-4.3 V);

FIG. 5 is the charge and discharge curve of comparative example 3 (current density: 100 mA g⁻¹, electrolyte: 1.0 mol L⁻¹, sodium hexafluorophosphate is dissolved in propylene carbonate, and the voltage window: 2.0-4.3 V);

FIG. 6 is the charge and discharge curve of comparative example 4 (current density: 100 mA g⁻¹, electrolyte: 1.0 mol L⁻¹, sodium hexafluorophosphate is dissolved in propylene carbonate, and the voltage window: 2.0-4.3 V);

FIG. 7 is the charge and discharge curve of example 1 (current density: 100 mA g⁻¹, electrolyte: 1.0 mol L⁻¹, sodium hexafluorophosphate is dissolved in propylene carbonate, and the voltage window: 2.0-4.3 V);

FIG. 8 is the charge and discharge curve of example 2 (current density: 100 mA g⁻¹, electrolyte: 1.0 mol L⁻¹, sodium hexafluorophosphate is dissolved in propylene carbonate, and the voltage window: 2.0-4.3 V);

FIG. 9 is the cycling performance of comparative example 1 and example 1 in pouch cell (current density: 50 mAg⁻¹, electrolyte: 1.0 molL⁻¹, sodium hexafluorophosphate is dissolved in propylene carbonate, and the voltage window: 1.9-4.2 V);

FIG. 10 is the cycling performance of comparative examples 1-4 and example 1 in CR 2032 coin cell (current density: 100 mAg⁻¹, electrolyte: 1.0 molL⁻¹, sodium hexafluorophosphate is dissolved in propylene carbonate, and the voltage window: 2.0-4.3 V).

### DETAILED DESCRIPTION OF PREFERRED EXAMPLES

Next, the present invention will be further described in detail through specific examples. The following examples are only descriptive but not limiting, and cannot be used for defining the scope of protection of the present invention.

The purities of sodium carbonate, potassium carbonate, manganese oxide, nickel oxide, ferric oxide, titanium dioxide, zinc oxide, organic solvents and sodium salts used in examples are all no less than 99%.

### Example 1

In this example, a cathode material was synthesized and the performance in sodium ion battery was investigated. The active material was Na_{0.95}K_{0.05}Ni_{0.32}Zn_{0.08}Fe_{0.1}Mn_{0.3}Ti_{0.2}O₂, which was synthesized by the following steps:

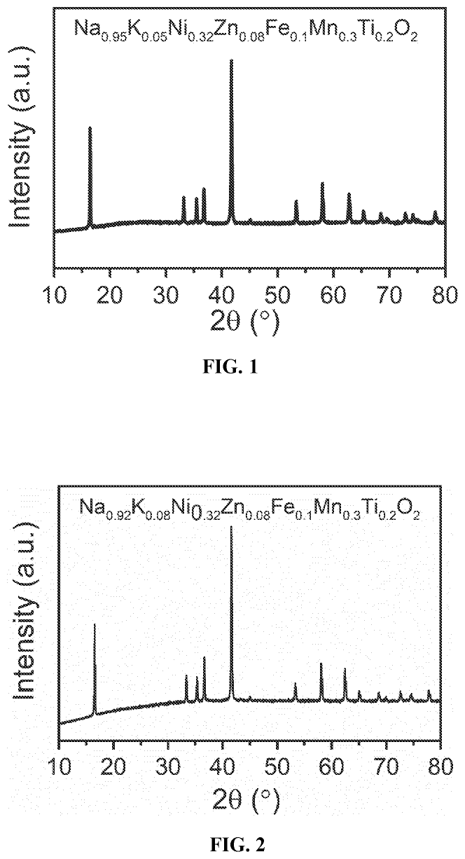

1.05 mmol of sodium carbonate, 0.05 mmol of potassium carbonate, 0.64 mmol of nickel oxide, 0.16 mmol of zinc oxide, 0.1 mmol of iron oxide, 0.4 mmol of titanium dioxide and 0.6 mmol of manganese dioxide were homogeneously mixed and then operated at 500 rmin⁻¹ for 6 h by ball milling; it then was dried for 30 min in an oven at 90° C. The dried sample was ground, tableted at the pressure of 20 MPa, sintered for 15 h at 900° C., slowly cooled at 10° C. min⁻¹ and then rapidly transferred to a glove box in an argon atmosphere for storage. The XRD graph of Na_{0.95}K_{0.05}Ni_{0.32}Zn_{0.08}Fe_{0.1}Mn_{0.3}Ti_{0.2}O₂ is as shown in FIG. 1. The results show that Na_{0.95}K_{0.05}Ni_{0.32}Zn_{0.08}Fe_{0.1}Mn_{0.3}Ti_{0.2}O₂ belongs to hexagonal crystal system.

The electrode was prepared by in a mass percentage 80% Na_{0.95}K_{0.05}Ni_{0.32}Zn_{0.08}Fe_{0.1}Mn_{0.3}Ti_{0.2}, 10% conductive black, and 10% polyvinylidene fluoride. The counter electrode is metal sodium, and the counter electrode of the pouch cell is pre-sodiated hard carbon. The solvent of the electrolyte is propylene carbonate. The electrolyte salt is sodium hexafluorophosphate, and the molar concentration in the electrolyte is 1.0 molL⁻¹.

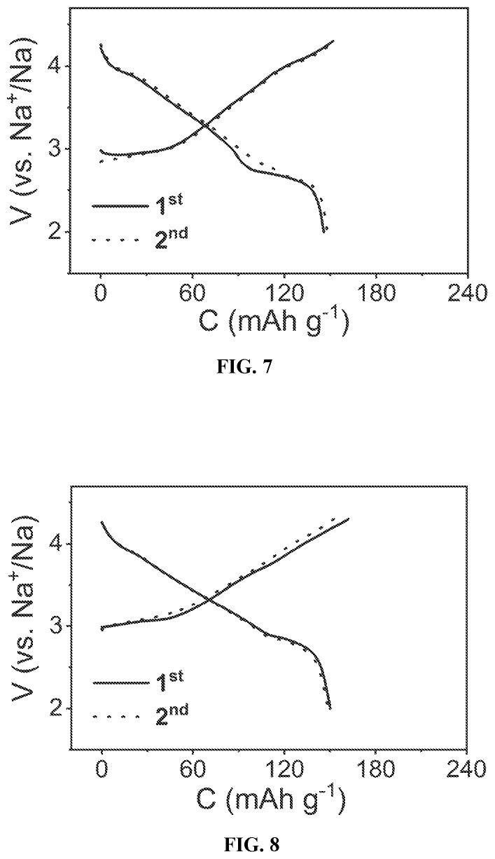

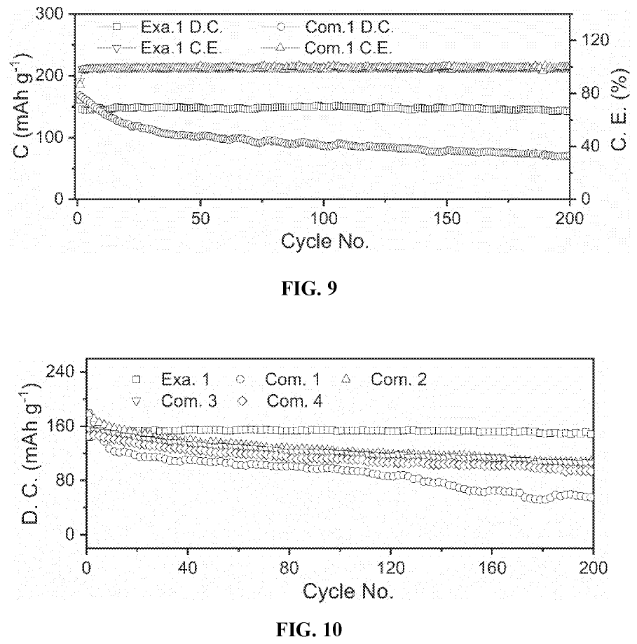

The prepared cathode material, sodium metal, electrolyte and other necessary battery accessories are assembled into a CR2032 coin cell. Meanwhile, the prepared cathode material, pre-sodiated hard carbon, electrolyte and other necessary battery accessories such as an aluminum plastic film and a pole ear were assembled into a pouch cell. The charge and discharge measurement was performed by using a Land CT2001A battery test system, and the test voltage window of the CR2032 button battery and the pouch cell were 2.0-4.3V and 1.9-4.2V, respectively. FIG. 7 is the charge and discharge curve of Na_{0.95}K_{0.05}Ni_{0.32}Zn_{0.08}Fe_{0.1}Mn_{0.3}Ti_{0.2}O₂ electrode in first two cycles, the current density is 100 mAg⁻¹, and the reverse specific capacity is 151.2 mAhg⁻¹. FIG. 9 is the cycle curve of pouch cells of comparative example 1 and example 1, and the current density is 50 mAg⁻¹. The results show that the capacity retention of example 1 is maintained ˜100% after 200 cycles, in a sharp contrast to 41.51% of comparative example 1 after 200 cycles. FIG. 10 is the cycle curve of comparative examples 1-4 and example 1 in CR 2032 coin cell, and the current density is 100 mAhg⁻¹. The results indicate that the capacity retention of example 1 after 200 cycles is ˜100%, while the capacity retentions of comparative examples 1-4 after 200 cycles are 30.5%, 61.2%, 65.8% and 69.0%, respectively.

### Example 2

This example is different from example 1 in that:

The active material of the cathode was Na_{0.92}K_{0.08}Ni_{0.32}Zn_{0.08}Fe_{0.1}Mn_{0.3}Ti_{0.2}O₂, which was synthesized by the following steps:

1.01 mmol of sodium carbonate, 0.08 mmol of potassium carbonate, 0.64 mmol of nickel oxide, 0.16 mmol of zinc oxide, 0.1 mmol of iron trioxide, 0.4 mmol of titanium dioxide and 0.6 mmol of manganese dioxide were homogeneously mixed and then operated at 500 r min⁻¹ for 6 h by ball milling; it then was dried for 30 min in an oven at 90° C. The dried sample was ground, tableted at the pressure of 20 MPa, sintered for 15 h at 900° C., slowly cooled at 10° C. min⁻¹ and then rapidly transferred to a glove box in an argon atmosphere for storage. The XRD graph of Na_{0.92}K_{0.08}Ni_{0.32}Zn_{0.08}Fe_{0.1}Mn_{0.3}Ti_{0.2}O₂ is shown in FIG. 2. The results show that Na_{0.92}K_{0.08}Ni_{0.32}Zn_{0.08}Fe_{0.1}Mn_{0.3}Ti_{0.2}O₂ belongs to hexagonal crystal system.

The preparation method of the electrode slice comprising the Na_{0.92}K_{0.08}Ni_{0.32}Zn_{0.08}Fe_{0.1}Mn_{0.3}Ti_{0.2}O₂ active material was the same as that in example 1.

The above-mentioned prepared cathode material, sodium metal, electrolyte and other necessary battery accessories are assembled into a CR2032 coin cell. The charge and discharge measurement was performed by using a Land CT2001A battery test system, and the test voltage interval of the CR2032 button battery was 2.0-4.3V. FIG. 8 is the charge and discharge curve of Na_{0.92}K_{0.08}Ni_{0.32}Zn_{0.08}Fe_{0.1}Mn_{0.3}Ti_{0.2}O₂ electrode in first two cycles, the current density is 100 mAg⁻¹, and the reverse specific capacity is 150.3 mAhg⁻¹.

### Comparative Example 1

In this comparative example, a cathode material was synthesized and the performance in sodium ion battery was investigated. The active material was NaNi_{0.5}Mn_{0.5}O₂, which was synthesized by the following steps:

1.05 mmol of sodium carbonate, 1.0 mmol of nickel oxide and 1.0 mmol of manganese dioxide were evenly mixed and dispersed in a mortar and subjected to ball milling at 500 rmin⁻¹ for 6 h, and it was then dried for 30 min in an oven at 90° C. The dried sample was ground, tableted at the pressure of 20 MPa, sintered for 15 h at 900° C., slowly cooled at 10° C. min⁻¹ and then rapidly transferred to a glove box in an argon atmosphere for storage.

The preparation method of the electrode slice comprising the O3-NaNi_{0.5}Mn_{0.5}O₂ active material was the same as that in example 1.

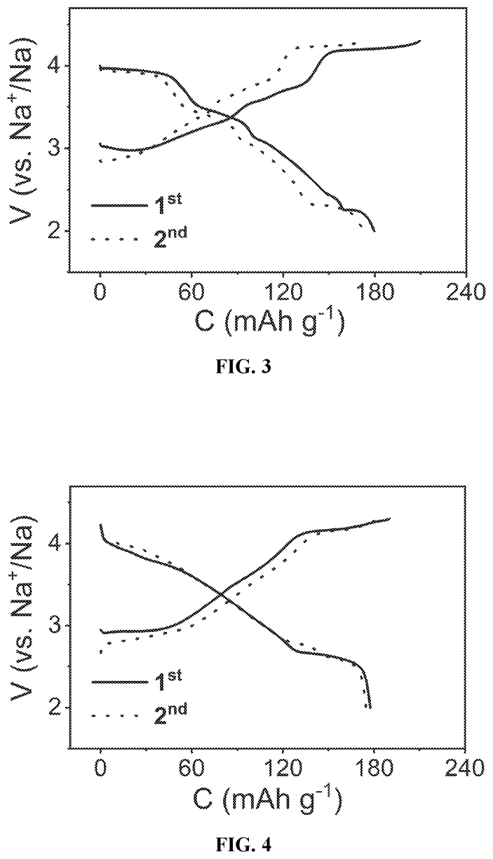

The prepared cathode material, sodium metal, electrolyte and other necessary battery accessories were assembled into a CR2032 button battery. Meanwhile, the prepared cathode material, pre-sodiated hard carbon, electrolyte and other necessary battery accessories such as an aluminum plastic film and a pole ear were assembled into pouch cell. The charge and discharge measurement was performed by using a Land CT2001A battery test system, and the test voltage window of the CR2032 button battery and the pouch cell were 2.0-4.3V and 1.9-4.2V, respectively. FIG. 3 is the charge and discharge curve of NaNi_{0.5}Mn_{0.5}O₂ electrode, the current density is 100 mAg⁻¹, and the reverse specific capacity is 179.6 mAhg⁻¹. FIG. 9 is the cycle curve of pouch cells of comparative example 1 and example 1, and the current density is 50 mA g⁻¹. The results show that the capacity retention of example 1 is maintained ˜100% after 200 cycles, in a sharp contrast to 41.51% of comparative example 1 after 200 cycles.

### Comparative Example 2

In this comparative example, a cathode material was synthesized and the performance of its sodium ion battery was investigated. The active material was NaNi_{0.4}Fe_{0.2}Mn_{0.4}O₂, which was synthesized by the following steps:

1.05 mmol of sodium carbonate, 0.8 mmol of nickel oxide, 0.2 mmol of iron oxide and 0.8 mmol of manganese dioxide were homogeneously mixed and then operated at 500 r min⁻¹ for 6 h by ball milling; it then was dried for 30 min in an oven at 90° C. The dried sample was ground, tableted at the pressure of 20 MPa, sintered for 15 h at 900° C., slowly cooled at 10° C. min⁻¹ and then rapidly transferred to a glove box in an argon atmosphere for storage. The preparation method of the electrode comprising the NaNi_{0.4}Fe_{0.2}Mn_{0.4}O₂ active material was the same as that in example 1.

The above-mentioned cathode material, sodium metal, electrolyte and other necessary battery accessories are assembled into a CR2032 button battery. The charge and discharge measurement was performed by using a Land CT2001A battery test system, and the test voltage window of the CR2032 button battery was 2.0-4.3V. FIG. 4 is the charge and discharge curve of NaNi_{0.4}Fe_{0.2}Mn_{0.4}O₂ electrode, the current density is 100 mA g⁻¹, and the reverse specific capacity was 175.6 mAhg⁻¹.

### Comparative Example 3

In this comparative example, a cathode material was synthesized and the performance of its sodium ion battery was investigated. The active material was NaNi_{0.32}Zn_{0.08}Fe_{0.2}Mn_{0.4}O₂, which was synthesized by the following steps:

1.05 mmol of sodium carbonate, 0.64 mmol of nickel oxide, 0.16 mmol of zinc oxide, 0.1 mmol of ironoxide, 0.8 mmol of manganese dioxide, 2.2 mmol of sodium acetate and 0.8 mmol of nickel oxide were homogeneously mixed and then operated at 500 r min⁻¹ for 6 h by ball milling; it then was dried for 30 min in an oven at 90° C. The dried sample was ground, tableted at the pressure of 20 MPa, sintered for 15 h at 900° C., slowly cooled at 10° C. min⁻¹ and then rapidly transferred to a glove box in an argon atmosphere for storage.

The preparation method of the electrode comprising the NaNi_{0.32}Zn_{0.08}Fe_{0.2}Mn_{0.4}O₂ active material was the same as that in example 1.

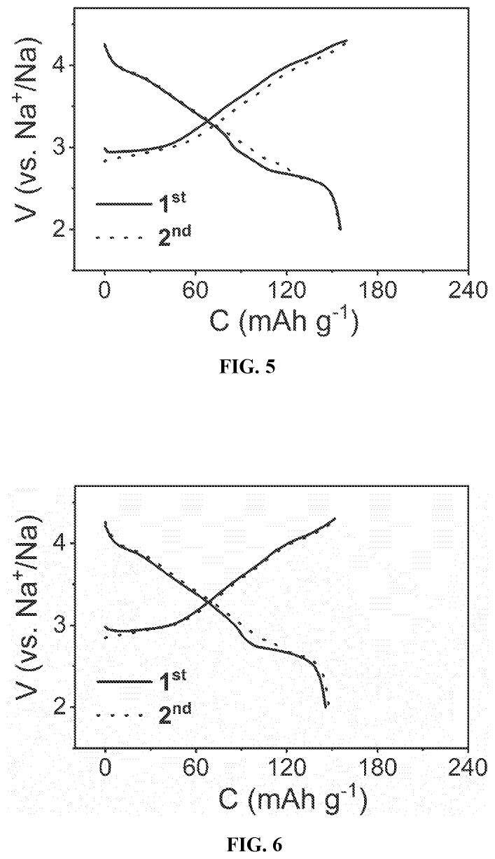

The above-mentioned cathode material, sodium metal, electrolyte and other necessary battery accessories are assembled into a CR2032 button battery. The charge and discharge measurement was performed by using a Land CT2001A battery test system, and the test voltage window of the CR2032 button battery was 2.0-4.3V. FIG. 5 is the charge and discharge curve of NaNi_{0.32}Zn_{0.08}Fe_{0.2}Mn_{0.4}O₂ electrode, the current density is 100 mA g⁻¹, and the reverse specific capacity was 155.2 mAhg⁻¹.

### Comparative Example 4

In this comparative example, a cathode material was synthesized and the performance of its sodium ion battery was investigated. The active material was Na_{0.95}K_{0.05}Ni_{0.32}Zn_{0.08}Fe_{0.2}Mn_{0.4}O₂, which was synthesized by the following steps:

1.01 mmol of sodium carbonate, 0.05 mmol of potassium carbonate, 0.64 mmol of nickel oxide, 0.16 mmol of zinc oxide, 0.1 mmol of iron oxide and 0.8 mmol of manganese dioxide were homogeneously mixed and then operated at 500 r min⁻¹ for 6 h by ball milling; it then was dried for 30 min in an oven at 90° C. The dried sample was ground, tableted at the pressure of 20 MPa, sintered for 15 h at 900° C., slowly cooled at 10° C. min⁻¹ and then rapidly transferred to a glove box in an argon atmosphere for storage.

The preparation method of the electrode comprising the Na_{0.95}K_{0.05}Ni_{0.32}Zn_{0.08}Fe_{0.2}Mn_{0.4}O₂ active material was the same as that in example 1.

The above-mentioned cathode material, sodium metal, electrolyte and other necessary battery accessories are assembled into a CR2032 button battery. The charge and discharge measurement was performed by using a Land CT2001A battery test system, and the test voltage window of the CR2032 button battery was 2.0-4.3V. FIG. 6 is the charge and discharge curve of Na_{0.95}K_{0.05}Ni_{0.32}Zn_{0.08}Fe_{0.2}Mn_{0.4}O₂ electrode in first two cycles, the current density is 100 mA g⁻¹, and the reverse specific capacity was 149.8 mAhg⁻¹.

Table 1 shows the comparison of the cycle stability of example 1 and comparative examples 1-8 at different voltages and meanwhile gives their references and patent data as comparison.

TABLE 1

| Sample | Voltage range (V) | Cycle stability |
|---|---|---|
| Example 1 | 2.0-4.3 | ^{~}100% |
| Comparative example 1 | 2.0-4.3 | 30.5% |
| Comparative example 2 | 2.0-4.3 | 61.2% |
| Comparative example 3 | 2.0-4.3 | 65.8% |
| Comparative example 4 | 2.0-4.3 | 69.0% |
| Comparative example 5 | 2.0-4.0 | 70.0% |
| Comparative example 6 | 2.0-4.0 | 85.0% |
| Comparative example 7 | 2.0-4.2 | 94.5% |
| Comparative example 8 | 2.0-4.0 | 82.8% |

Comparative example 5 is a battery material in Designing Air-Stable O3-Type Cathode Materials by Combined Structure Modulation for Na-Ion Batteries, with a chemical formula of NaNi_{0.45}Cu_{0.05}Mn_{0.4}Ti_{0.1}O₂.

Comparative example 6 is a battery material in Ti-Substituted NaNi_{0.5}Mn_{0.5-x}TiₓO₂ Cathodes with Reversible O3-P3 Phase Transition for High-Performance Sodium-Ion Batteries, with a chemical formula of NaNi_{0.5}Mn_{0.2}Ti_{0.3}O₂.

Comparative 7 is a battery material in patent CN116093326A, with a chemical formula of NaCo_{0.1}Ni_{0.2}Mn_{0.2}Mg_{0.1}Ti_{0.2}Cu_{0.1}Sn_{0.1}O₂@NaTi₂(PO₄)₃.

Comparative example 8 is a battery material in Boron-doped sodium layered oxide for reversible oxygen redox reaction in Na-ion battery cathodes, with a chemical formula of NaLi_{1/9}Ni_{2/9}Fe_{2/9}Mn_{4/9}B_{1/50}O₂.

It can be seen from Table 1 that the electrochemical cycle stability in example 1 is the most excellent, which is far higher than those in other comparative examples, the capacity retention rate is 100%, and meanwhile stable cycling performance at a high cut-off voltage of 4.3V is achieved.

The above descriptions are only preferred examples of the present invention. It should be noted that several deformations and improvements can also be made by persons of ordinary skill in the art without departing from the concept of the present invention, which are all included within the scope of protection of the present invention.

1. A cathode material, which has a chemical formula of Na₁₋ₓKₓNi_{y}Fe_{z}Mn_{d}TiₘZn_{1-y-z-d-m}O₂, (0<x≤0.1, 0<y, z, d, and m≤1) belongs to hexagonal system with a space group of R-3m;
an arrangement subsequence of transition metal layers is ABCABC, and Ni, Fe, Zn, Mn and Ti elements occupy in a transition metal layer and are arranged in a disordered subsequence;
Na and K elements sit in a same alkali metal layer and are arranged in a disordered subsequence, and a sodium ion battery assembled by using the cathode material has a specific capacity of 150 mAhg⁻¹ at a high cut-off charge voltage of 4.3V;
wherein the cathode material is prepared into electrodes for the sodium ion battery;
wherein the electrodes comprise the following components by mass percent: 80% cathode material, 10% conductive black and 10% polyvinylidene fluoride.

2. The cathode material according to claim 1, wherein x is 0.03-0.10, y is 0.20-0.50, z is 0.05-0.20, d is 0.10-0.40, and m is 0.10-0.20.

3. The cathode material according to claim 2, wherein x is 0.05-0.08, y is 0.30-0.40, z is 0.08-0.12, d is 0.20-0.30, and m is 0.15-0.20.

4. The cathode material according to claim 3, wherein the chemical formula is Na_{0.95}K_{0.05}Ni_{0.32}Zn_{0.08}Fe_{0.1}Mn_{0.3}Ti_{0.2}O₂ or Na_{0.92}K_{0.08}Ni_{0.32}Zn_{0.08}Fe_{0.1}Mn_{0.3}Ti_{0.2}O₂.

5. The cathode material according to claim 1, wherein a preparation method comprises the following steps:
(1) performing ball milling and mixing on a sodium source, a potassium source, a nickel source, a manganese source, an iron source, a titanium source and a zinc source according to a stoichiometric ratio, and drying to obtain a precursor; and
(2) calcining the precursor obtained in step (1) for 10-15 h at 800-1000° C., and then cooling at a cooling rate of 5-10° C. min⁻¹ to obtain the cathode material for the sodium ion battery.

6. The cathode material according to claim 5, wherein the sodium source is sodium carbonate or sodium oxide, the potassium source is potassium carbonate, the nickel source is nickel oxide, the manganese source is manganese dioxide, the iron source is iron oxide, the titanium source is titanium dioxide, and the zinc source is zinc oxide.

7. (canceled)

8. (canceled)
